(19) United States
(12) Patent Application Publication
(10) Pub. No.: US 2015/0278736 A1
(43) Pub. Date: Oct. 1, 2015

(54) FRAMEWORK TO OPTIMIZE THE SELECTION OF PROJECTS AND THE ALLOCATION OF RESOURCES WITHIN A STRUCTURED BUSINESS ORGANIZATION UNDER TIME, RESOURCE AND BUDGET CONSTRAINTS

(71) Applicants: Cosimo Spera, San Francisco, CA (US); Samir Mukadam, San Ramon, CA (US); Clifford Sean McBride, Santa Clara, CA (US); Charles Lawrence Read, Menlo Park, CA (US)

(72) Inventors: Cosimo Spera, San Francisco, CA (US); Samir Mukadam, San Ramon, CA (US); Clifford Sean McBride, Santa Clara, CA (US); Charles Lawrence Read, Menlo Park, CA (US)

(73) Assignee: INNOTAS, San Francisco, CA (US)

(21) Appl. No.: 14/667,559

(22) Filed: Mar. 24, 2015

Related U.S. Application Data
(60) Provisional application No. 61/967,714, filed on Mar. 25, 2014.

(51) Int. Cl. G06Q 10/06; G06F 17/30

(52) U.S. Cl. CPC G06Q 10/06313; G06F 17/30598; G06F 17/3053; G06F 17/30864

(57) ABSTRACT

Aspects of the present disclosure are presented for efficiently allocating resources to projects in a schedule under time, resource and budget constraints. In some embodiments, a method is presented. The method may include accessing variables for determining an efficient allocation of resources in the schedule, including a set of project dependency values indicating which projects in the plurality of projects must be completed as requisite for completing other projects in the plurality of projects. The method may also include determining a dependency path indicating an ordering of projects to be completed, based on the set of project dependency values, wherein a project in the dependency path cannot be started until all preceding projects in the dependency path are completed; and determining an efficient selection of projects to be completed within the time horizon that maximizes an optimization goal, based on the dependency path and constrained by budget expenditures.

### CROSS REFERENCE TO RELATED APPLICATIONS

This application claims the benefits of U.S. Provisional Application 61/967,714, filed Mar. 25, 2014, and titled, “Randomized framework to optimize the selection of projects and the allocation of resources within a structured business organization under multiple constraints,” the disclosure of which is incorporated herein in its entirety and for all purposes.

### TECHNICAL FIELD

The subject matter disclosed herein generally relates to processing data. In some embodiments, the present disclosures relate to methods and apparatuses for providing a framework to optimize the selection of projects and the allocation of resources within a structured business organization.

### BACKGROUND

A common goal of business organizations and other companies is to find an efficient use of available resources to complete various tasks or projects within time and budget constraints. In some cases, a level of efficiency may be based on how much profit is earned, given a particular allocation of resources to a specified number of projects. Computers utilizing various optimization algorithms may be relied on to determine a proposed schedule for what projects should be completed in order to utilize resources efficiently. However, known algorithms may be computationally inefficient, particularly when a vast number of projects may be considered simultaneously. In some cases, conventional algorithms may be unable to solve this optimization problem the more projects are being added for consideration. It is desirable therefore to develop new algorithms and heuristics that can determine a schedule of projects in a computationally efficient manner.

### BRIEF SUMMARY

Methods, systems and computer readable media are presented for allocating resources to multiple projects in an organization under various time, resource, and budget constraints. In some embodiments, a method is presented. The method may include: accessing, by a processor, a plurality of projects; accessing, by the processor, a time horizon indicating a length of time to complete at least a subset of projects in the plurality of projects; accessing, by the processor, a plurality of resources, wherein each resource in the plurality of resources specifies one or more functions that can be performed by the resource toward completing at least one project in the plurality of projects; accessing, by the processor, for each resource in the plurality of resources, a budget expenditure indicating a maximum available capacity that each resource can be used across the plurality of projects; accessing, by the processor, for each project in the plurality of projects, a cost constraint associated with completing said project; accessing, by the processor, for each project in the plurality of projects, a benefit value indicating an amount of benefit gained with completing said project; accessing, by the processor, a set of project dependency values indicating which projects in the plurality of projects must be completed as requisite for completing other projects in the plurality of projects; determining, by the processor, at least one dependency path indicating an ordering of projects among the plurality of projects to be completed, based on the set of project dependency values, wherein a project in the at least one dependency path cannot be started until all preceding projects in the at least one dependency path are completed; and determining, by the processor, an efficient selection of projects among the plurality of projects to be completed within the time horizon based on a comparison between the benefit values of each project in the efficient selection of projects and the cost constraints of each project in the efficient selection of projects, the efficient selection based on the at least one dependency path and determining an efficient utilization of the plurality of resources to complete the efficient selection of projects, constrained by the budget expenditures for each resource.

In some embodiments, determining the at least one dependency path includes: partitioning the plurality of projects into a plurality of clusters; computing a cluster dependency path for each cluster indicating, for each project in the cluster, a sequence of projects among the plurality of projects linked by the project dependency values associated with said project in the cluster; performing a merging operation of the cluster dependency paths to generate the at least one dependency path; and pruning at least a subset of at least one of the cluster dependency paths that is not relevant to the at least one dependency path during the merging operation. In some embodiments, the merging operation comprises splicing at least two cluster dependency paths together, a selection of the at least two cluster dependency paths to be spliced based on at least one project being in common among the at least two cluster dependency paths.

In some embodiments, determining the at least one dependency path includes: determining a first dependency path based on the set of project dependency values; determining a second dependency path based on the set of project dependency values; ranking the first dependency path over the second dependency path based on a comparison between estimated returns of the first and second path dependencies; and allocating along a timeline constrained by the time horizon the projects in the first dependency path before allocating along the timeline the projects in the second dependency path.

In some embodiments, determining the efficient selection of projects among the plurality of projects to be completed includes determining an efficient placement for a project on a timeline constrained by the time horizon, the efficient placement based on a time-length for completing the project, an amount of resources needed to complete the project, and a project budget defining maximum financial costs for the project. In some embodiments, determining the efficient placement for the project includes: matching the resources with roles in the project; prioritizing a selection of the resources to be matched with the roles; and prioritizing a selection of the roles to be matched with the resources. In some embodiments, prioritizing a selection of the resources includes: selecting preferred resources earlier than non-preferred resources; assigning sticky resources earlier than non-sticky resources, the sticky resources indicating a resource that was assigned to a time-interval prior to the role being considered; assigning inflexible resources earlier than flexible resources; assigning resources to roles that match a best-fit description of the roles; and favoring resources with a longer availability horizon over resources with a shorter availability horizon. In some embodiments, prioritizing a selection of the roles comprises: matching scarce roles before less scarce roles; matching roles whose contours have a longer non-zero sequence of demands before roles with shorter contours; and matching roles with larger time commitments before roles with shorter time commitments.

In some embodiments, determining the efficient selection of projects among the plurality of projects to be completed includes determining reasons for why a project among the plurality of projects is excluded among the efficient selection of projects. In some embodiments, determining why the project is excluded includes: determining if a budget shortfall caused the project to be excluded; determining if a resource shortfall caused the project to be excluded; determining if a timeline shortfall caused the project to be excluded; and determining if a dependency path shortfall caused the project to be excluded.

In some embodiments, determining the efficient selection of projects among the plurality of projects to be completed comprises revising a set of project constraints to determine if at least one more project among the plurality of projects not currently included among the efficient selection of projects can be included among the efficient selection. In some embodiments, revising the set of project constraints includes: determining if revising a number of roles for completing the efficient selection of projects results in one or more projects being included among the efficient selection of projects; determining if increasing at least one budget associated with the efficient selection of projects results in one or more projects being included among the efficient selection of projects; or determining if increasing capacity of a role within a project among the efficient selection of projects results in one or more projects being included among the efficient selection of projects.

In some embodiments, determining the efficient selection of projects among the plurality of projects to be completed within the time horizon is based further on maximizing the comparison between the benefit values of each project in the efficient selection of projects and the cost constraints of each project in the efficient selection of projects.

In some embodiments, a system is presented. The system may include: a memory configured to store data including: a plurality of projects; a time horizon indicating a length of time to complete at least a subset of projects in the plurality of projects; a plurality of resources, wherein each resource in the plurality of resources specifies one or more functions that can be performed by the resource toward completing at least one project in the plurality of projects; for each resource in the plurality of resources, a budget expenditure indicating a maximum available capacity that each resource can be used across the plurality of projects; for each project in the plurality of projects, a cost constraint indicating financial costs associated with completing said project; for each project in the plurality of projects, a benefit value indicating an amount of benefit gained with completing said project; and a set of project dependency values indicating which projects in the plurality of projects must be completed as requisite for completing other projects in the plurality of projects. The system may also include a processor coupled to the memory and configured to: access the plurality of projects, the time horizon, the plurality of resources, the budget expenditure for each resource in the plurality of resources, the cost constraint for each project in the plurality of projects, the benefit value for each project in the plurality of projects, and the set of project dependency values; determine at least one dependency path indicating an ordering of projects among the plurality of projects to be completed, based on the set of project dependency values, wherein a project in the at least one dependency path cannot be started until all preceding projects in the at least one dependency path are completed; and determine an efficient selection of projects among the plurality of projects to be completed within the time horizon based on a comparison between the benefit values of each project in the efficient selection of projects and the cost constraints of each project in the efficient selection of projects, the efficient selection based on the at least one dependency path and determining an efficient utilization of the plurality of resources to complete the efficient selection of projects, constrained by the budget expenditures for each resource.

In some embodiments, a non transitory computer readable medium is presented. The computer readable medium may include instructions that, when interpreted by a processor, cause a machine to perform operations comprising: accessing a plurality of projects; accessing a time horizon indicating a length of time to complete at least a subset of projects in the plurality of projects; accessing a plurality of resources, wherein each resource in the plurality of resources specifies one or more functions that can be performed by the resource toward completing at least one project in the plurality of projects; accessing for each resource in the plurality of resources, a budget expenditure indicating a maximum available capacity that each resource can be used across the plurality of projects; accessing for each project in the plurality of projects, a cost constraint indicating financial costs associated with completing said project; accessing for each project in the plurality of projects, a benefit value indicating an amount of benefit gained with completing said project; accessing a set of project dependency values indicating which projects in the plurality of projects must be completed as requisite for completing other projects in the plurality of projects; determining at least one dependency path indicating an ordering of projects among the plurality of projects to be completed, based on the set of project dependency values, wherein a project in the at least one dependency path cannot be started until all preceding projects in the at least one dependency path are completed; and determining an efficient selection of projects among the plurality of projects to be completed within the time horizon based on a comparison between the benefit values of each project in the efficient selection of projects and the cost constraints of each project in the efficient selection of projects, the efficient selection based on the at least one dependency path and determining an efficient utilization of the plurality of resources to complete the efficient selection of projects, constrained by the budget expenditures for each resource.

### BRIEF DESCRIPTION OF THE DRAWINGS

Some embodiments are illustrated by way of example and not limitation in the figures of the accompanying drawings.

FIG. 1 is a network diagram illustrating an example network environment suitable for performing aspects of the present disclosure, according to some embodiments.

FIG. 2 shows an example display of a graphical user interface for receiving time horizon and optimization information to a system for allocating resources to multiple projects, according to some embodiments.

FIG. 3 shows a second example display of a graphical user interface for receiving project information to a system for allocating resources to multiple projects, according to some embodiments

FIG. 4 shows a third example display of a graphical user interface for receiving constraint information to a system for allocating resources to multiple projects, according to some embodiments.

FIG. 5 shows one example display, e.g., an executive summary, for an overall schedule listing a number of projects that maximizes an optimization goal, according to some embodiments.

FIG. 6 shows a second example display, e.g., a graphical chart, describing additional attributes about the projects to be included in the proposed schedule, according to some embodiments.

FIG. 7 shows a third example display, e.g., a project listing, describing other attributes about the projects to be included in the proposed schedule, according to some embodiments.

FIG. 8 shows a fourth example display, e.g., a timeline summary, describing other attributes about the projects to be included in the proposed schedule, according to some embodiments.

FIG. 9 shows a fifth example display, e.g., a resource utilization summary, describing other attributes about the projects to be included in the proposed schedule, according to some embodiments.

FIG. 10 shows a sixth example display, e.g., additional miscellaneous statistics, describing other attributes about the projects to be included in the proposed schedule, according to some embodiments.

FIG. 11 describes an example methodology for generating a schedule of projects to be completed within a specified time horizon, according to some embodiments.

FIG. 12A provides an example methodology for determining the dependency paths in block 1116 of FIG. 11, according to some embodiments.

FIG. 12B provides a graphical depiction of some examples of the directed acyclic graphs.

FIG. 12C provides an example for generating the complete dependency paths, consistent with the descriptions in FIG. 12A.

FIG. 13 provides an example methodology for determining allocating the projects in block 1118 of FIG. 11, according to some embodiments.

FIG. 14 is a block diagram illustrating components of a machine, according to some example embodiments, able to read instructions from a machine-readable medium and perform any one or more of the methodologies discussed herein.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Systems, methods, and apparatuses are presented for allocating resources to multiple projects in an organization under various time, resource, and budget constraints. As referred to herein, a “project” may be defined as a planned piece of work that has a specific purpose for a company, and may yield a certain value for the company, expressed in various ways, including, for example, profit in a dollar amount, gained reputation, a score for each project, estimated long term strategic value, other quantifiable metrics or any combination thereof. To complete a project, a number of resources may need to be devoted to the project over a period of time, and therefore the project may have an associated specified amount of resources needed, an estimated cost, an estimated time for completion, and one or more budgets specifying a maximum available capacity for each type of resource. As referred to herein, a “resource” may be defined as a stock of qualified professionals which can perform a set of tasks for which they are qualified. In other cases, resources can include other tangible tools and machines, such as computers, printing machines, scientific equipment, construction equipment, and the like. A common goal of business organizations and other companies is to find an efficient use of available resources to complete various tasks or projects within time and budget constraints. In some cases, a level of efficiency may be based on how much profit is earned, given a particular allocation of resources to a specified number of projects.

Standard approaches to find optimal or efficient solutions have included modeling this problem as a linear program and solving the linear program using computers following operations research theory and known heuristics. However, this optimization problem is known to be NP-hard, meaning that computing resources needed to solve this problem increase exponentially as the size of the problem (e.g., the number of projects) increases linearly. Thus, while conventional methods may solve this problem adequately for a smaller number of projects to be considered and balanced, this optimization problem may become intractable the more projects (e.g., more than 50) that are to be considered. Since business organizations may deal generally with consideration of 150 projects or more on average, conventional approaches to finding efficient or optimal solutions may be unable to provide satisfactory answers within a reasonable time limit.

Aspects of the present disclosure are presented for allocating resources to multiple projects, given specified time and budget constraints, in a computationally efficient manner. In some embodiments, a processor may be configured to determine one or more dependency paths of projects, where a dependency path indicates an ordering of the projects to be completed based on designations that some projects are to be completed before other projects can be completed. In a set of many projects, in some embodiments, the set of projects may be partitioned into clusters of projects, wherein a cluster dependency path may be computed for each cluster, indicating the dependencies to other projects (including projects not within the cluster). In some embodiments, multiple dependency paths among the entire set of projects may be determined by emerging the cluster dependency paths, based on the indicated dependencies within each cluster. These multiple dependency paths may then be ranked according to some optimization goal, such as maximizing profit or maximizing some other type of benefit value compared against costs. The term “maximizing” may refer to achieving an absolute maximum, in the sense that a maximum value compared to all other possible values is achieved. In some embodiments, the term “maximizing” refers to achieving a relative maximum, in the sense that a value is achieved that is better than all other values under a given set of constraints and prescribed methodologies utilizing those constraints. The projects within the highest ranked dependency paths may then be allocated into a project schedule that may be constrained by a specified time horizon. In some embodiments, the partitioning of the projects into clusters may be based on a random selection.

In general, the partitioning of the projects into clusters may allow for parallelized computation, thereby reducing the amount of time needed to determine an efficient solution to the optimization problem presented herein. In addition, partitioning the entire set of projects into clusters and computing first the cluster dependency paths allows a computing processor to consider only a subset of projects (e.g., 15 projects), rather than the entire set (e.g., 150 projects), thereby avoiding the exponential increase in computational resources needed when trying to tackle the entire set as a whole. Moreover, partitioning the entire set of projects into clusters allows a computing processor to reduce the number of irrelevant comparisons between projects that are not dependent on one another, thereby further reducing the amount of computational resources needed.

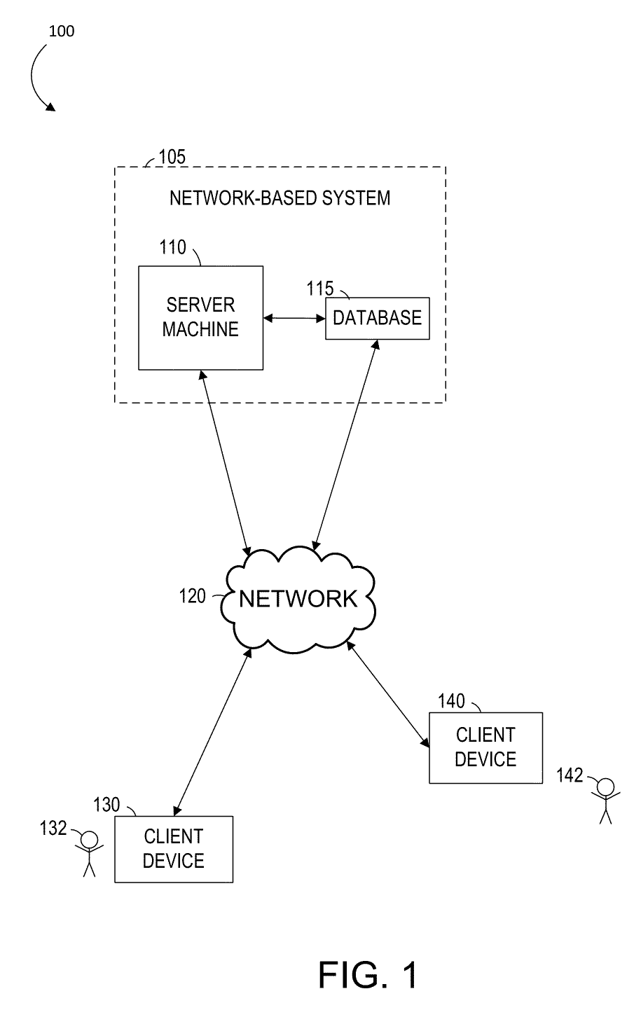

Referring to FIG. 1, a network diagram illustrating an example network environment 100 suitable for performing aspects of the present disclosure is shown, according to some embodiments. The example network environment 100 includes a server machine 110, a database 115, a first client device 130 for a first client 132, and a second client device 140 for a second client 142, all communicatively coupled to each other via a network 120. The server machine 110 may form all or part of a network-based system 105 (e.g., a cloud-based server system configured to provide one or more services to the first client device 130, and first and second client devices 130 and 140). The server machine 110, the first client device 130, and the second client device 140, may each be implemented in a computer system, in whole or in part, as described below with respect to FIG. 17.

Also shown in FIG. 1 are the first client 132 and the second client 142. One or more of the first and second clients 132 and 142 may be a human user, a machine user (e.g., a computer configured by a software program to interact with the first client device 130), or any suitable combination thereof (e.g., a human assisted by a machine or a machine supervised by a human). The first client 132 may be associated with the first client device 130 and may be a user of the first client device 130. For example, the first client device 130 may be a desktop computer, a vehicle computer, a tablet computer, a navigational device, a portable media device, a smartphone, or a wearable device (e.g., a smart watch or smart glasses) belonging to the first user 132. Likewise, the second client 142 may be associated with the second client device 140.

Any of the machines, databases 115, first client device 130, or second client devices 140 shown in FIG. 1 may be implemented in a general-purpose computer modified (e.g., configured or programmed) by software (e.g., one or more software modules) to be a special-purpose computer to perform one or more of the functions described herein for that machine, database 115, or devices 130, and 140. For example, a computer system able to implement any one or more of the methodologies described herein is discussed below with respect to FIG. 17. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 120 may be any network that enables communication between or among machines, databases 115, and devices (e.g., the server machine 110 and the first client device 130). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof. Accordingly, the network 120 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 120 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

Example User Interfaces for Receiving Inputs

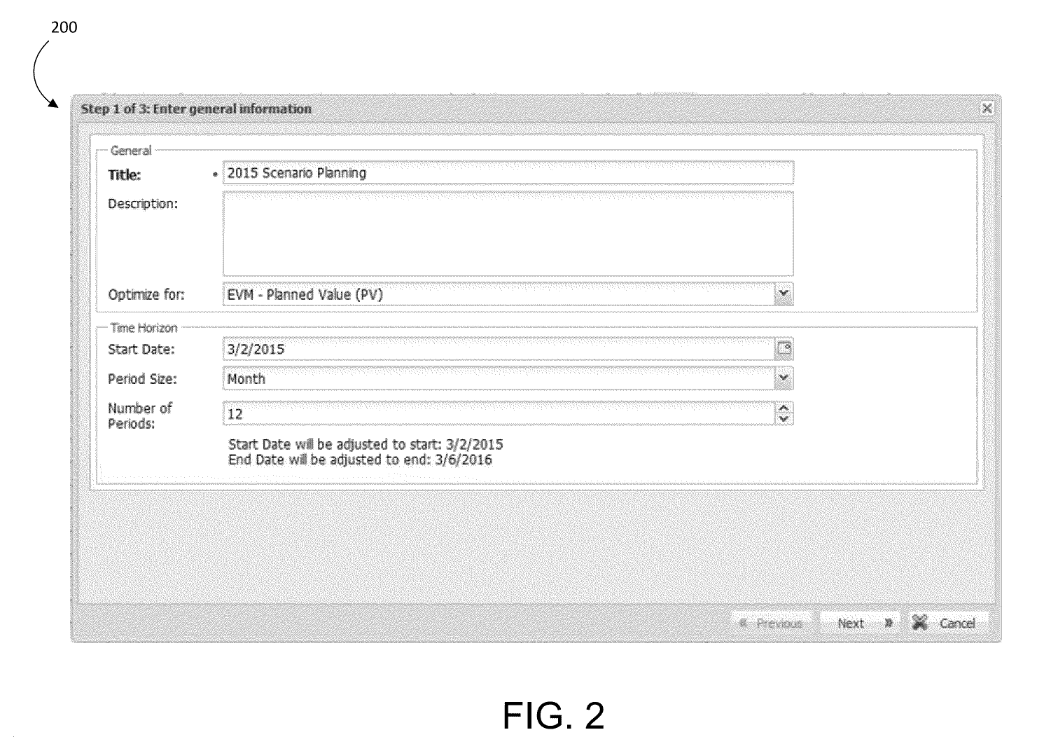

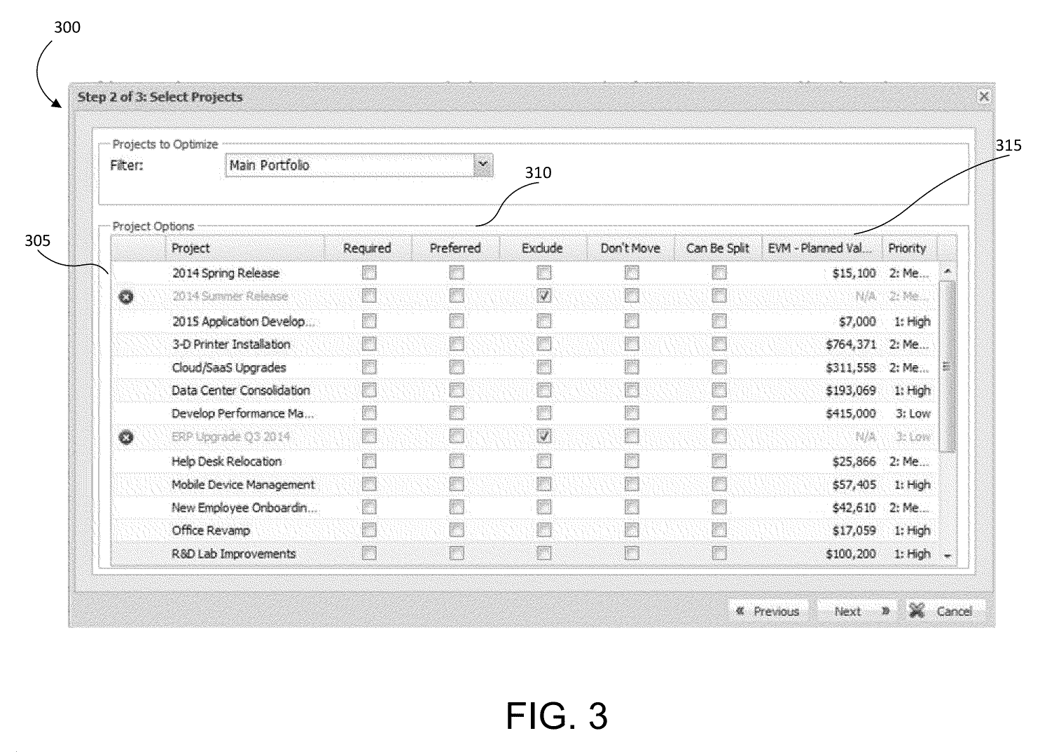

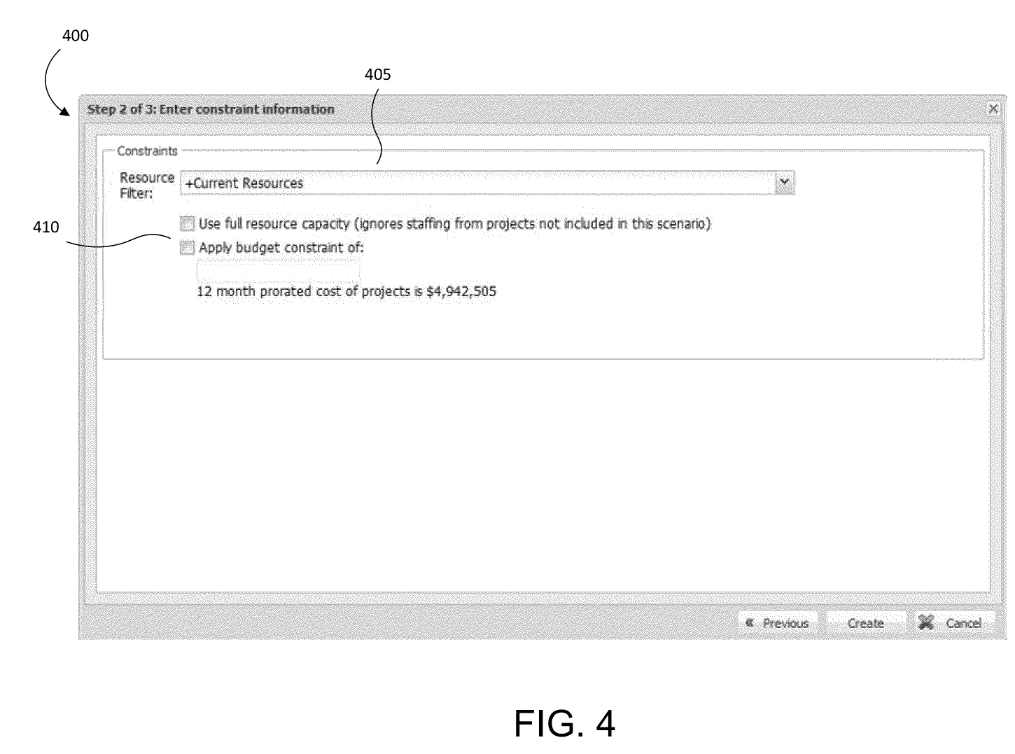

Referring to FIG. 2, illustration 200 shows an example display of a graphical user interface for receiving inputs to a system for allocating resources to multiple projects, according to some embodiments. The example display in illustration 200 may be presented to a user, such as clients 132 or 142, on a device, such as client devices 130 or 140. The inputs received at the example display, including the inputs described in FIGS. 3 and 4, below, may then be accessed by a system, such as the network-based system 105, which may be utilized to determine how projects should be scheduled, according to some embodiments.

Here, the example display may first allow a user to generate a planning schedule of various projects across a specified timeframe based on some optimization goal. In this case, the optimization goal is specified as “EVM-Planned Value (PV),” which may indicate that the user wants to find a set of projects that maximizes estimated value of the projects. In addition, the specified timeframe shown here under the “Time Horizon” display box, shows that the user wishes to plan a schedule of projects across 12 months time starting from the specified start date.

Referring to FIG. 3, illustration 300 shows a second example display of a graphical user interface for receiving inputs to a system for allocating resources to multiple projects, according to some embodiments. Here, the user may be presented with numerous projects that may be considered for being placed in the 12 month schedule, as shown by the list of projects 305. In some embodiments, the user may also be able to specify certain exclusions or other modifiers to each of the projects, as shown in the project options 310. For example, the user can specify to exclude certain projects from consideration, resulting in those projects being grayed out, as some examples. In other cases, the user can add additional constraints to the optimization problem by specifying which projects should be required or merely preferred. In addition, the user may also be able to specify whether a project can be split up, in the event that there may be only so much time remaining in the schedule and the user may want to allow partial projects to be completed or not. In some embodiments, the listing of the projects may also include the estimated value to be earned 315 by completing each of the projects. In some embodiments, the listing of projects may also include designation of priority or importance, for example like the designations as shown. In some embodiments, the projects may also have associated project dependencies, not shown, specifying one or more projects that are determined to be completed before said project can be started. In some embodiments, the listing of projects 305 may also include other information about the projects, such as estimated times to complete, estimated costs to complete, types of resources needed, and the like.

Referring to FIG. 4, illustration 400 shows a third example display of a graphical user interface for receiving inputs to a system for allocating resources to multiple projects, according to some embodiments. Here, the user may be presented with options for specifying what kinds of resources should be considered when devoting resources to the various projects. In some embodiments, the resources available for use in the multiple projects may be viewed as constraints when considering what projects should be completed in the specified time horizon. As mentioned above, a resource may be defined as a type of work professional who possesses a certain set of skills useful for completing a certain set of tasks. Examples of these types of resources may include a computer programmer, a business analyst, an administrative assistant, a market researcher, a project manager, and the like. In other cases, a resource can also include tangible assets, such as a number of computers, amounts of printing material, construction materials, warehouse space, and the like.

In some embodiments, the user may be able to filter what resources may be considered for devoting to the projects according to the specified time horizon, such as through the resource filter 405. Here, a default is for all current resources to be considered, which may mean all resources that are known in the company's databases, such as payroll staff, inventory, available warehouse and office space, and the like. The utility of each of the resources may have been previously specified and entered into the system. The resource filter 405 may allow for other options, such as limiting the resources by schedule, level of experience, type of experience, or even expanding the list to include known contractors or vendors, as some examples.

In some embodiments, the user may also be able to specify additional constraints, such as the options 410. Here, the user may also be able to add any additional financial constraints to further limits the amount of resources that may be considered, based on known constraints for completing the projects in the specified time horizon. In some embodiments, additional constraints can be considered that may be apparent to those with ordinary skill in the art, and embodiments are not so limited.

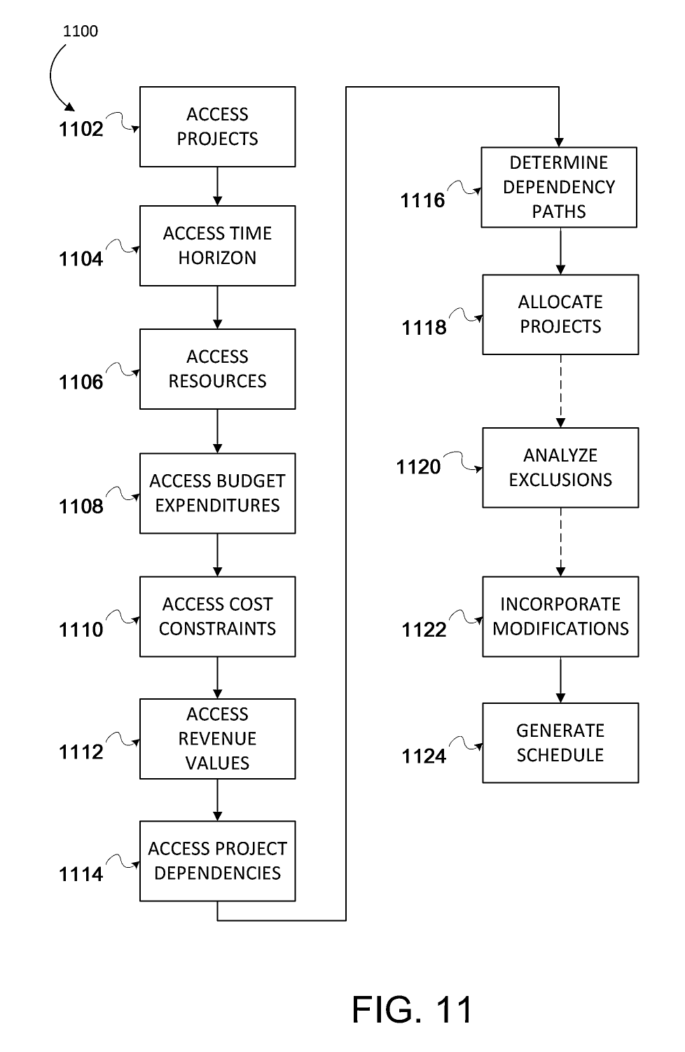

In some embodiments, a system according to aspects of the present disclosure, such as the network-based system 105, may access all of the information supplied by the user and associated with each of the projects, e.g., as described in FIGS. 2-4, and may determine a schedule of projects across the specified time horizon that efficiently utilizes the resources within given budgetary expenditures while maximizing the optimization goal, e.g., maximizing profit or some other type of benefit value compared against costs. Example techniques for determining this schedule are described below, with respect to FIGS. 11-13.

Example Outputs

In some embodiments, after having determined a proposed schedule of projects that maximizes the optimization goal and takes into account the available resources within specified budget constraints, a system according to aspects of the present disclosure, such as the network-based system 105, may supply various outputs to a user reflecting these results.

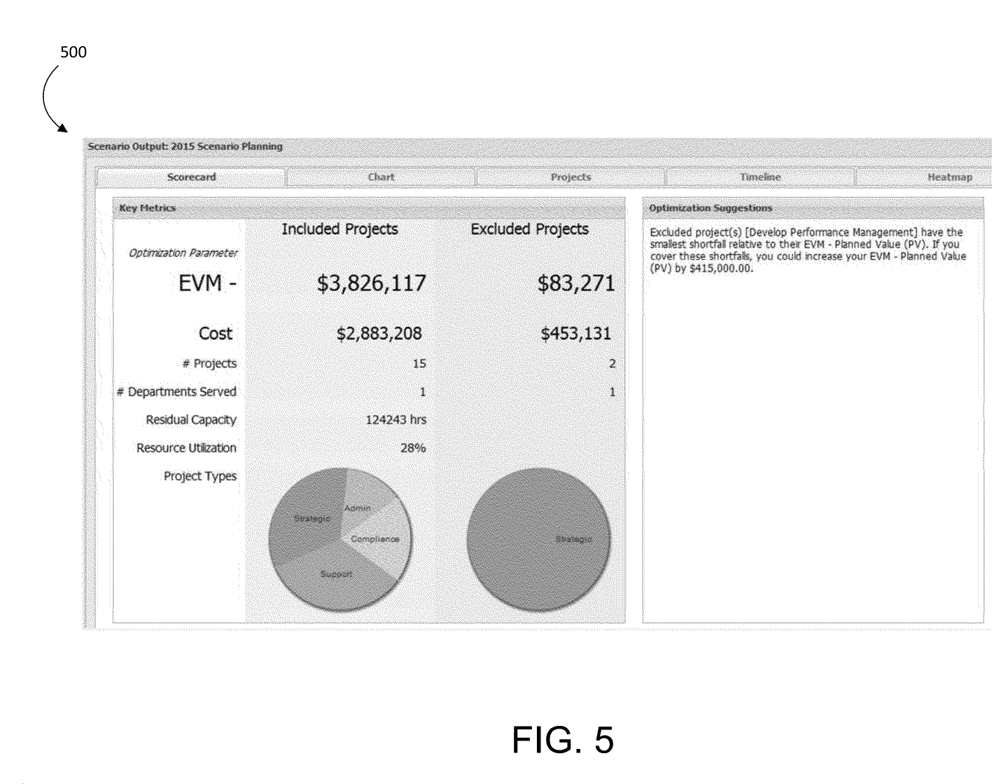

Referring to FIG. 5, illustration 500 shows one example display for an overall schedule listing a number of projects that maximizes an optimization goal, according to some embodiments. The example display in illustration 500 may represent an executive summary of sorts, highlighting the estimated value of the included projects within the time horizon. Additional information can include estimated costs for completing the project, the number of projects, how many departments or divisions within the company are served or are benefited by completion of the projects currently included in the schedule, any residual capacity for the kinds of resources available, corresponding resource utilization as a percentage of available resources, and a breakdown of the types of projects included in the proposed schedule, as some examples. In some embodiments, a listing or summary of excluded projects can also be considered or displayed. In some embodiments, the system may allow for additional inputs to consider excluded projects to be fit into the schedule through various modifications, examples of which will be described more below.

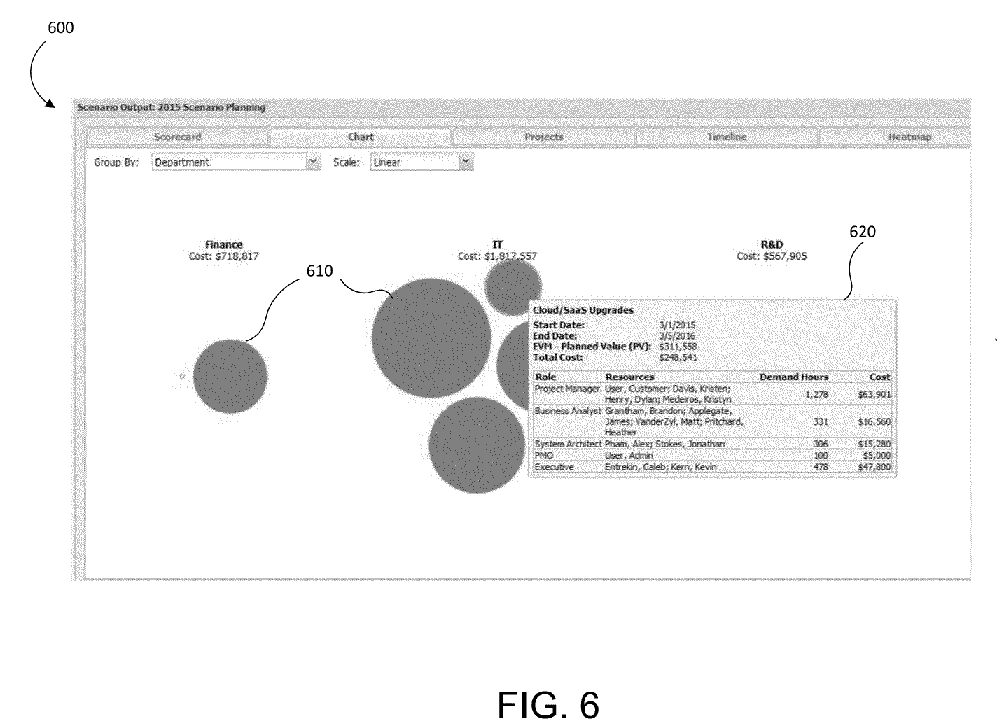

Referring to FIG. 6, illustration 600 shows a second example display describing additional attributes about the projects to be included in the proposed schedule, according to some embodiments. In this case, the example display may provide a graphical depiction of various attributes about the projects. For example, the circles 610 may each represent different projects that are included in the proposed schedule, where their size may describe an attribute about the project, such as estimated value to be gained by completing the project. The circles 610 may be grouped by a common theme, such as a category or division for which the project belongs to. In addition, in some embodiments, more detailed charts, such as the chart 620, may be provided for each project describing various attributes about the project, such as a planned start and end date, estimated value to be gained by completing the project, total cost, and the types of roles that may be needed to complete the project, fulfilled by various resources. Other types of information pertinent to each project and apparent to those with ordinary skill in the art, consistent with the descriptions herein may also be included, and embodiments are not so limited.

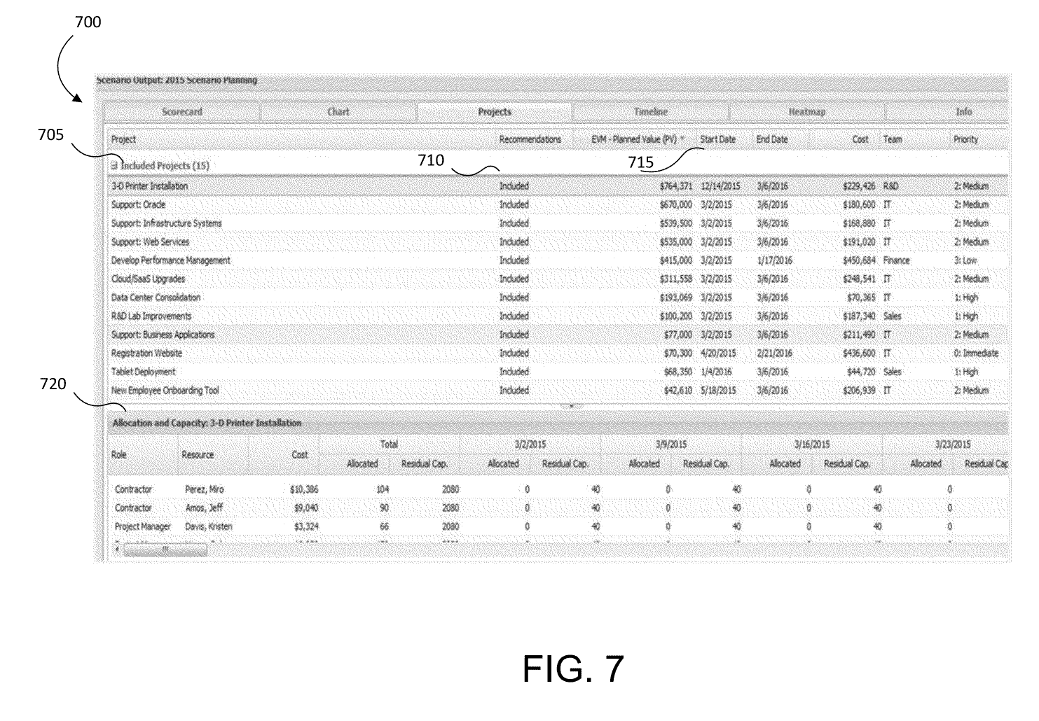

Referring to FIG. 7, illustration 700 shows a third example display describing other attributes about the projects to be included in the proposed schedule, according to some embodiments. Here, a listing of projects 705 may be displayed in a list form. Various other information may be included, such as a recommended status 710 of each project (e.g., “included,” “excluded,” etc.), Estimated value for each project, estimated start dates and end dates 715, estimated cost, designated team to which each project belongs, designated level of priority or importance of each project, and the like.

In some embodiments, upon a selection of a particular project in the list, a more detailed description of the project may be displayed in secondary display 720. For example, here, a listing of roles needed to complete the project are listed. In this case, various resources, listed as various people with particular skills, are allocated to the project, including various estimated capacities for each resource. These breakdowns may allow a user to see more clearly what resources and what costs are associated with each project. In some embodiments, the user may also be allowed to modify some of the proposed projects, resources, dates, and the like, based on these displays.

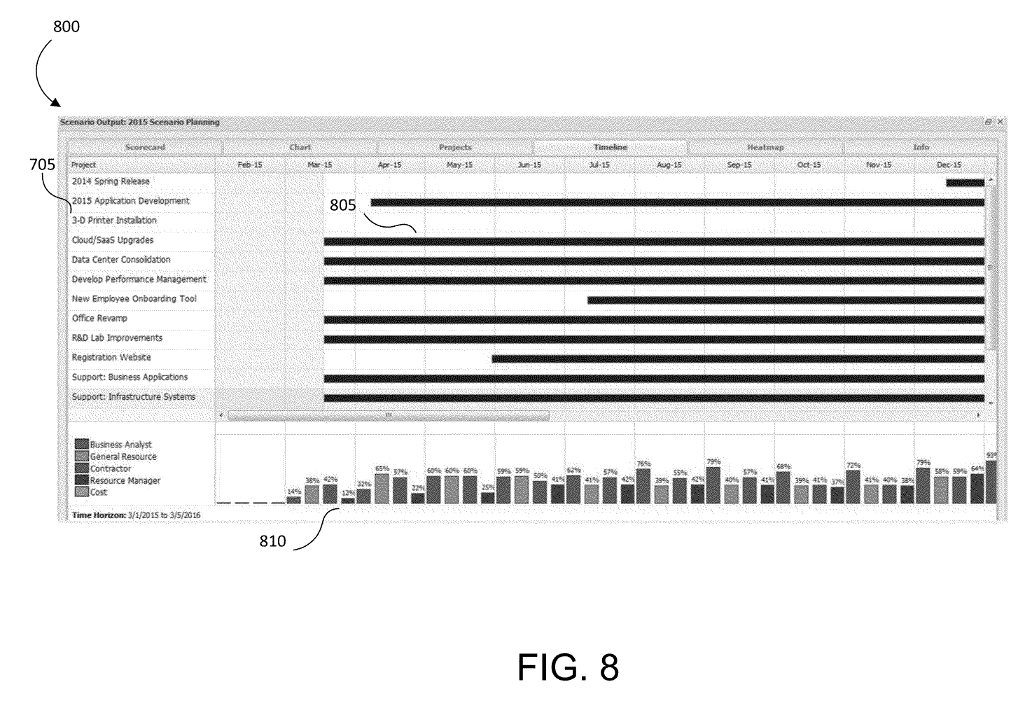

Referring to FIG. 8, illustration 800 shows a fourth example display describing other attributes about the projects to be included in the proposed schedule, according to some embodiments. In this case, the listing of projects 705 may be displayed in a timeline 805, visually showing through a series of bars an estimated time flow for how long the projects may last. The system through this view, may more clearly show which projects are running or being worked on simultaneously. In addition, while not shown here, this timeline view may also show which projects may be dependent on other projects, based on the estimated time for starting occurring just after another project finishes.

In some embodiments, this example display may also show bar graphs 810 of resource utilization during a specified time period, e.g., each month. Here for example, the utilization rates for the resources of business analyst, generic resources, contractors, and resource managers, are specified in the bar graphs 810. Other types of resources may be displayed, based on the types of resources that are being utilized, and embodiments are not so limited.

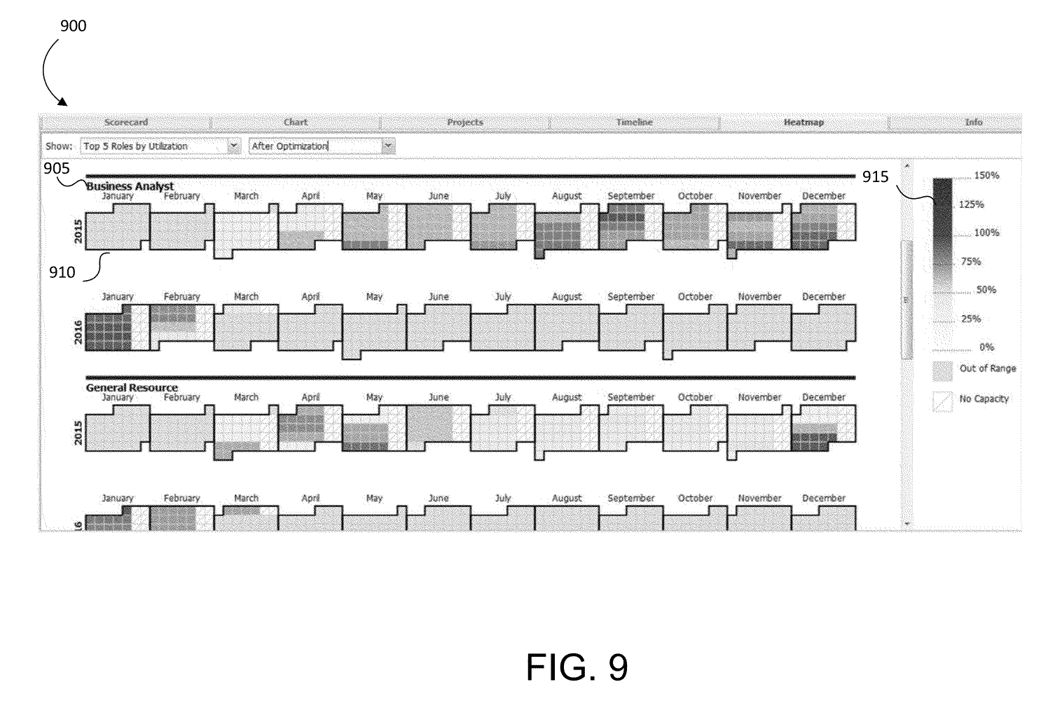

Referring to FIG. 9, illustration 900 shows a fifth example display describing other attributes about the projects to be included in the proposed schedule, according to some embodiments. In this case, the utilization of roles 905 across a specified timeframe may be illustrated in a sort of heat map 910. A role may be defined as an aggregation of resources with the same skills. As an example, each month of a specified time horizon may be displayed visually, along with a designation for how utilized the role is on each given day. In this case, the designations may be illustrated by different colors, corresponding to the percent utilization scale 915. In this way, a user may be able to see where a particular resource is over utilized or underutilized. Additional projects or other tasks might then be considered during the times when the resource is underutilized, or additional resources may be devoted at certain times where the resource is over utilized. As another example, the various resources may know when they might be able to take a vacation or know when to expect to have more free time.

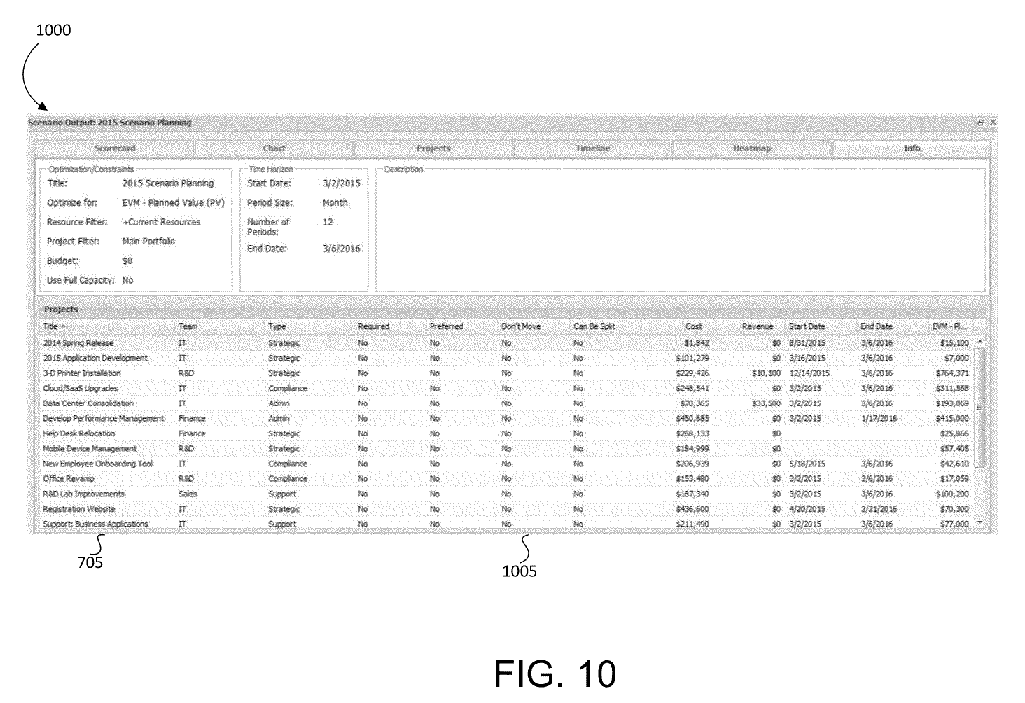

Referring to FIG. 10, illustration 1000 shows a sixth example display describing other attributes about the projects to be considered in the proposed schedule, according to some embodiments. In this example display, the system may provide an overall listing of the various projects that are included and excluded in the proposed schedule, along with various miscellaneous statistics 1005. These example statistics 1005 may be based on inputs received from the user into the system, or in other cases may be based on pre-designations already attributed it to the projects. For example, each of the projects in the project listing 705 may include a project type, whether it was specified that the project must be included, i.e., “Required,” whether it was specified that the project is preferred to be included, whether the project is allowed to be moved from a predesignated start time, and whether the project may be allowed to be split for being worked on at separate times. Other types of information pertinent for display and pertaining to the projects or the proposed schedule may be apparent to those with skill in the art and may also be contemplated herein, and embodiments are not so limited.

Example Optimization Algorithms

The following are example descriptions for how aspects of the present disclosure may determine a selection of projects to be completed within a specified time horizon, including how resources may be allocated to the projects, given various resource and budget constraints, according to some embodiments.

Referring to FIG. 11, flowchart 1100 describes an example methodology for generating a schedule of projects to be completed within a specified time horizon, according to some embodiments. The example methodology may be performed by a system or server of aspects of the present disclosure, such as network-based system 105, for example. In some embodiments, the network-based system 105 may access some inputs received from the user, such as the client 132 through client device 130. In some cases, some of the inputs may also be derived from a database, such as database 115, that were pre-programmed and used to describe various attributes about one or more of the projects.

In some embodiments, the example methodology may begin by first accessing all of the distinct variables that will be used to generate the proposed schedule. For example, at block 1102, the system may access a plurality of projects under consideration to be included in the proposed schedule. As previously mentioned, a project may be defined as a planned piece of work that has a specific purpose for a company, and may yield a certain value for the company. Examples of types of projects are described in the previous figures, such as FIGS. 3-10. In addition, at block 1104, the system may access a time horizon specifying a time range for how long the proposed schedule should be filled out for. For example, in the descriptions of the previous figures, an example time horizon was specified as over a 12 month period. In some embodiments, the time horizon may also include a start date, which may not necessarily be the present day.

At block 1106, the system may access a plurality of resources to be considered for allocation to the various projects in the schedule to be generated. As previously mentioned, a resource may be defined as a stock of qualified professionals which can perform a set of tasks for which they are qualified. In other cases, resources can include other tangible tools and machines, such as computers, printing machines, scientific equipment, construction equipment, and the like. Examples of types of resources are described in the previous figures, such as FIGS. 4-10. In some cases, the resources may have attributed skills that may better describe which resources can be of use to work on a project. Similarly, each project may have stated skills that are needed to be met in order for the project to be completed.

At block 1108, in some embodiments, the system may access a plurality of budget expenditures, each budget expenditure being associated to a particular resource, where each budget expenditure indicates a maximum available capacity that each resource can be used across the plurality of projects. An example of a budget expenditure may include a maximum hourly capacity of an employee per day or per week, such as eight hours per day or 40 hours per week. Another example of a budget expenditure may include a maximum hourly capacity for use in a laboratory, such as 15 hours per day, or a hundred hours per week. Another example of a budget expenditure may include a financial budget, such as $20,000 budgeted for utilizing a contractor, or $5000 to rent a bulldozer. In some embodiments, the budget expenditures associated with each resource may be already predesignated and stored in the database 115, while in other cases at least some of the budget expenditures may be specified by a user and received at the system through a user interface.

At block 1110, the system may also access a plurality of cost constraints, each cost constraint being associated with a particular project, and indicating an estimated financial cost associated with completing said project. In some embodiments, the cost constraints may be based on the estimated total value of all the resources that are estimated to be needed to complete the project. Examples of these associated costs may be described in the previous figures, such as FIGS. 5-10.

At block 1112, the system may also access a plurality of benefit values, each benefit value being associated with a particular project, and indicating an estimated value to be gained associated with completing said project. Examples of benefit values can include financial revenue expressed in a financial currency, or other types of value such as ranked score, increase productivity, increased energy savings, net present value (NPV), gained reputation by completing the project or other metrics used by a company and apparent to those with skill in the art. Examples of these associated values may be described in the previous figures, such as the EVM values in FIGS. 3 and 5-10.

At block 1114, the system may also access a plurality of project dependencies associated with each project, the project dependency values indicating which projects accessed in block 1102 must be completed as requisite for completing other projects. In some embodiments, these project dependency values may be expressed or represented in a dependency upper triangular matrix U of square dimension i, where i equals the number of accessed projects, and where Uᵢⱼ=1 if project i is requisite for project j, and Uᵢⱼ=0 otherwise. In some embodiments, the project dependencies may be listed with each project, wherein the system may be configured to generate the project dependency values, in some cases expressed in this upper triangular matrix U, based on the listed dependencies for each project. In other cases, the upper triangular matrix U may already be stored, such as in database 115. In some embodiments, some projects may not have any associated dependencies linked to them. Some of these “independent” projects may also not have any start or end times demanded of them, meaning they can be performed at any time without any requisite projects needing to be completed beforehand (i.e., they are “shiftable”). These “independent” and “shiftable” projects may be referred to herein as “floater” projects.

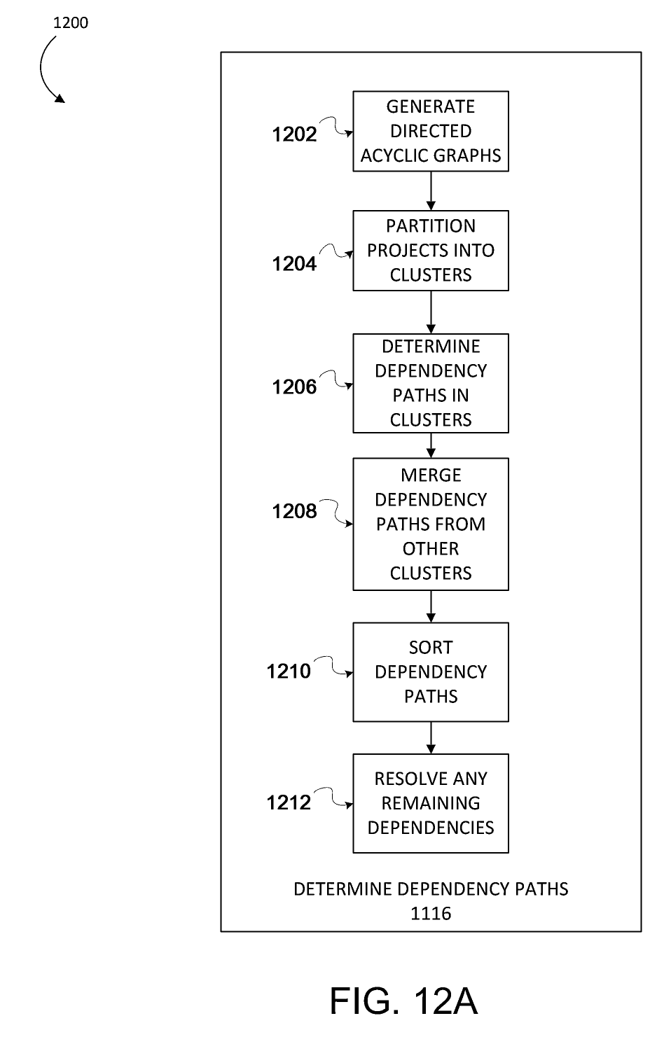

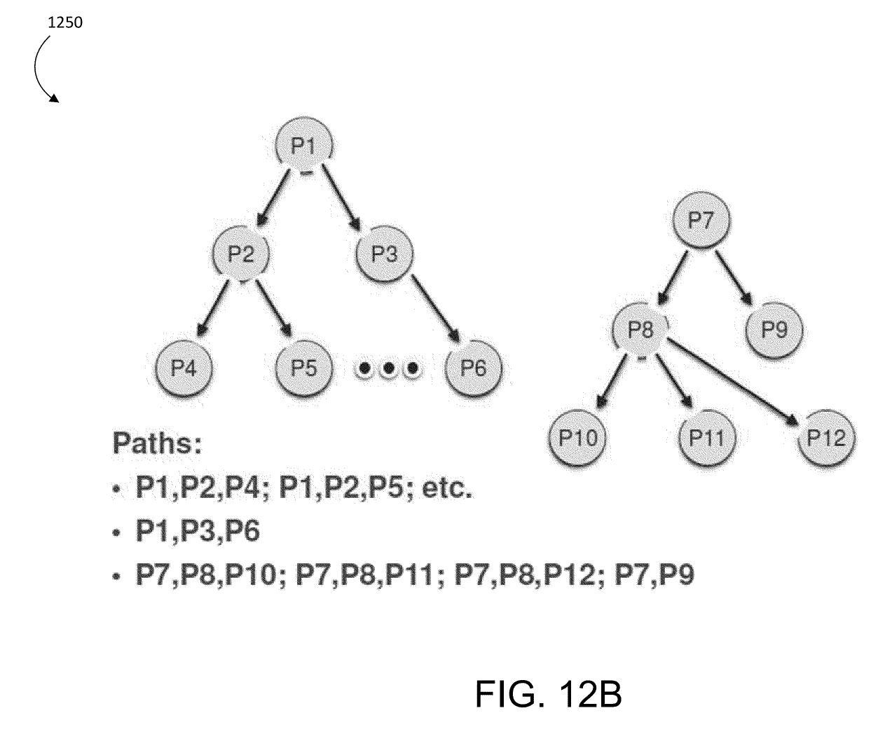

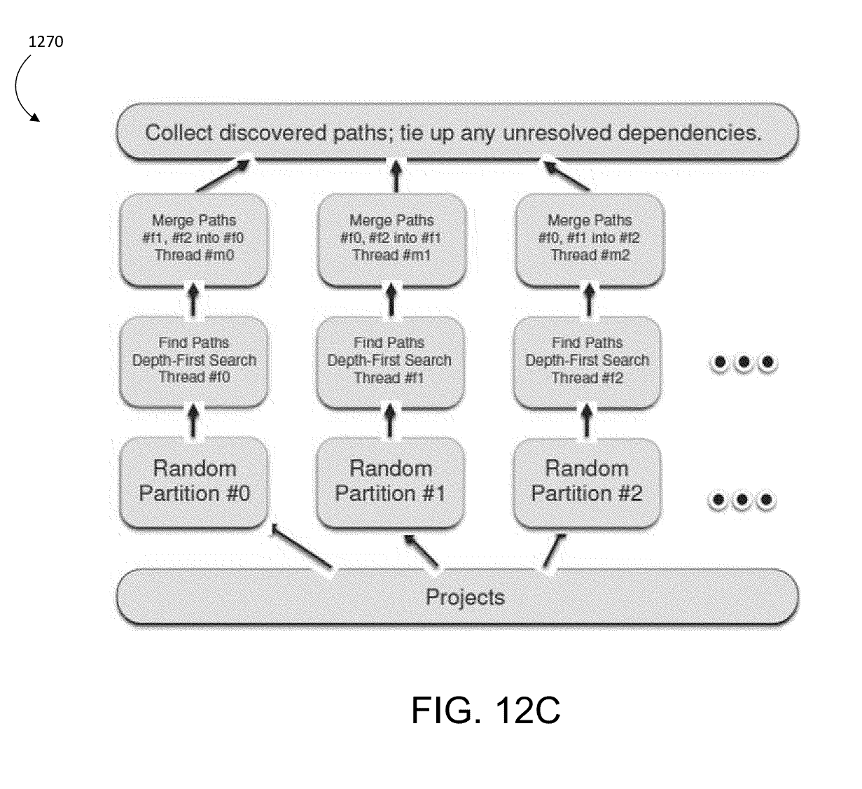

At block 1116, the system may determine one or more dependency paths, indicating a line or chain of projects to be completed in a specified order, based on the project dependency values. That is, a project in a dependency path cannot be started until proceeding projects in the dependency path are completed. In general, a project may be in a dependency path if it includes some time constraint associated with when said project can begin. For example, a project that has a specified start time or end time but has no literal projects that it depends from may still be placed in a dependency path, where in this case the project is in a dependency path of length 1. In some embodiments, multiple dependency paths may be determined. In some cases, some dependency paths will have one or more projects in common, meaning that completing a project may be a prerequisite before multiple projects can be started. In some embodiments, at block 1116, the system may also determine which projects may be floaters, and more generally, which projects have no dependencies. That is, some projects may have no dependencies and may have no time constraints placed on them, whereas other projects may have no dependencies but may have a certain required start date or end date. In some embodiments, additional details for determining a dependency path at this block are described below, in FIGS. 12A-12C.

At block 1118, the system may allocate the various projects into a proposed schedule. The length of time in the proposed schedule may be consistent with the time horizon accessed by the system. The proposed start date of the schedule may be based on the start date specified by a user, or in other cases may be based on a default start date equal to a number of days from the date the proposed schedule is generated.

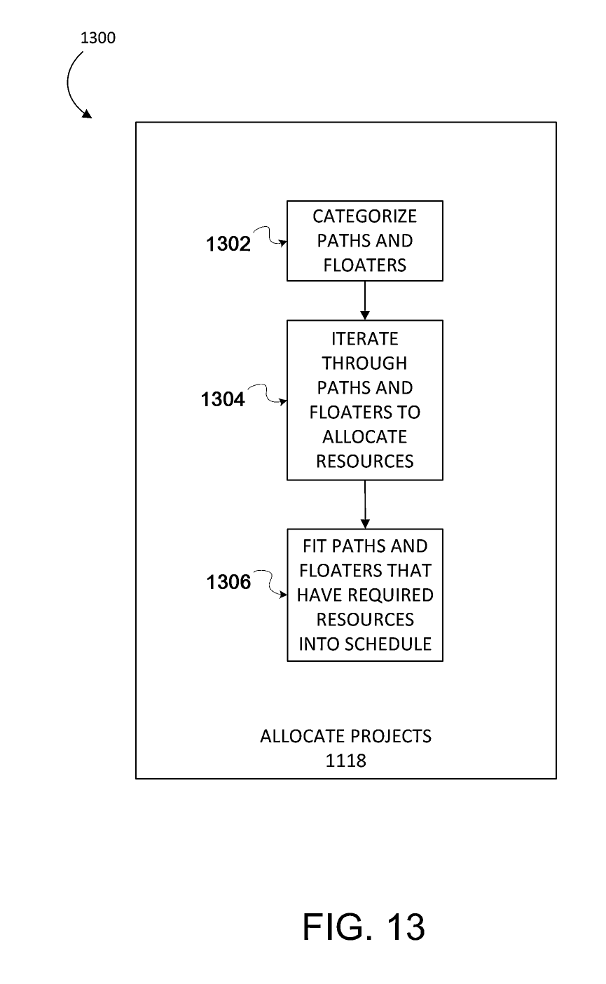

The system may allocate the various projects based on determining which projects better satisfy the optimization goal compared to other projects. In some embodiments, the projects may first be ranked or ordered based on how well they satisfy the optimization goal. However, if there are projects that are dependent on the completion of other projects, i.e., the projects lie along a dependency path, then it would not make sense to consider these projects in isolation or on their own. Thus, in some embodiments, the system may rank the value of the dependency paths based on the total value of the projects within the dependency paths. In some embodiments, further details to allocate the projects in order to best satisfy the optimization goal are described below, in FIG. 13.

In some embodiments, at block 1120, the proposed schedule based on the allocated projects from block 1118 may be modified by analyzing any excluded projects and the values that they may bring. The system may allow for excluded projects to be analyzed in order to allow a user some flexibility in considering ways to find more value by modifying the proposed schedule. In some embodiments, the excluded projects may be considered by increasing or relaxing one or more of the constraints that the proposed schedule is based on. For example, the system may allow for one or more budget variables to be increased, one or more resource variables to be increased, the time horizon to be expanded, and/or one or more of the dependency values to be modified such that one or more projects may not depend on the completion of other projects. The system may be configured to receive any of these modifications, typically inputted by a user, and in some cases the optimization algorithm of the present disclosure may be rerun to see what effects these modifications may have. For example, it may be determined that a project was excluded due to a budget shortfall, a resource shortfall, a timeline shortfall, a dependency shortfall, etc. These causes may be determined through the relaxing of one of these constraints that may subsequently allow the previously excluded project to now be included in the revised schedule. In some embodiments, the system may also allow for a time-shifting constraint to be relaxed, thereby allowing the system to determined that a project may have been excluded because the project cannot fit into its required starting time interval. In some embodiments, this exclusion analysis may be performed for multiple constraints, and/or to analyze the causes of multiple projects being excluded.

In some embodiments, at block 1122, the system may allow for one or more modifications to be proposed and included into a revised schedule, based on the analyzed exclusions. In some embodiments, based on the analyzed exclusions, the system may be configured to propose one or more suggestions for modifications that the user may then be able to pick and choose. For example, the system may be configured to propose one or more of the following suggestions based on the analyzed exclusions:

Adding 1 extra role to a project may result in 1 or more projects being allocated.

10% increase in budget may enable some group of projects to be allocated.

Increase capacity of single role in specific time-interval may enable a particular project to be allocated.

Increase in budget may result in large incremental gain in value relative to new cost adjustment.

Cover shortfalls small relative to project values may result in a better overall schedule value. For example, an employee who is on vacation and who is vital to a project may cause a project to not be included in a schedule initially, due to the project failing to be properly allocated under some formulations. However, it still may be valuable to include the project in the schedule, just at a different time within the time horizon, for example, when the employee is back from vacation and if the value of completing the project still makes it worth it to keep the project despite any potential delays or other costs.

The system may then be configured to accept one or more of these suggestions to be incorporated as modifications into the proposed schedule.

At block 1124, the system may then be configured to generate a schedule, based either on the ranked projects allocated to the proposed schedule from block 1118 or also including any incorporated modifications based on the analysis performed in blocks 1120 and 1122. In some embodiments, this schedule may be displayed in various different forms, such as through any of the examples described in FIGS. 5-10. The generated schedule may also include additional information that can be displayed describing various statistics and metrics about the schedule, such as any of the example statistics described in FIGS. 5-10.

Referring to FIG. 12A, flowchart 1200 provides an example methodology for determining the dependency paths in block 1116 of FIG. 11, according to some embodiments. Starting at block 1202, the system may transform the project dependency values, such as the values in the upper triangular matrix, into one or more directed acyclic graphs (DAGs). A DAG may be defined as a collection of vertices and directed edges, each edge connecting one vertex to another, such that there is no way to start at some vertex v and follow a sequence of edges that eventually loops back to v again. In this case, each vertex represents a project, and each directed edge from a first project represents a pointer to a second project based if the project dependency value of the second project says it is dependent on the first project. Multiple DAGs may be generated, based simply on following the project dependency values to create directed edges connecting the multiple projects together.

Alternatively, in some embodiments, other types of relationships other than one or more DAG's may be generated. In general, one or more data structures defining dependency relationships of each of the multiple projects, based on the project dependency values, and apparent to those with skill in the art may be generated, and embodiments are not so limited.

At block 1204, in some embodiments, the system may partition the set of projects into a plurality of clusters. Each cluster may include a subset of the projects out of the total number of projects. For example, if the entire set of projects to be considered for placement in a schedule is 150 projects, the system may partition the set of projects into 10 clusters, each with 15 projects. In some embodiments, the selection of the projects into the clusters is a randomized process. Since it is not known a priori how many dependencies each project has associated with it, it can be reasoned that on average, randomly partitioning the projects into clusters will result in the most likely even distribution of projects in terms of how many dependencies each cluster has. In other cases, the projects may be subdivided into clusters through other processes, such as sorting the projects in alphabetical order, evenly distributing the projects based on estimated values, the stream the projects based on types of roles required, etc. In some embodiments, the system may also determine an optimal number of projects to be included in each cluster. The optimal number of projects may be based on statistical analysis, where average computation time and average amount of resources (e.g., memory) are measured when the size of each cluster is varied. For example, it may have been previously determined that the optimal cluster size is 50 projects, in the sense that setting the cluster size to 49 or 51 projects results in more computation time and more resources used, on average. In some embodiments, the system may be configured to perform this statistical analysis in order to determine the optimal cluster size as part of partitioning the set of projects into clusters.

At block 1206, in some embodiments, the system may determine the dependency paths of the projects in a particular cluster, for each cluster. These mini sets of dependency paths within each cluster may be referred to herein as cluster dependency paths. That is, dependency paths may be formed only across projects within the same cluster. In some embodiments, these cluster dependency paths may be generated by performing a depth first search of the DAG of dependencies generated for that particular cluster. This is likely to lead to dependency paths that are incomplete for the time being, but generating the cluster dependency paths allows the system to not need to consider all projects and all dependencies at once. This may allow for the system to more efficiently handle large numbers of projects by breaking the entire set of projects into these subsets of clusters. In addition, in some embodiments, the process of determining the cluster path dependencies may be parallelized across multiple parallel processors, further increasing computation speed.

At block 1208, in some embodiments, the system may then merge the cluster dependency paths from other clusters together in order to form the complete dependency paths. That is, the system may then connect the incomplete edges of the cluster dependency paths by examining the incomplete edges of the other cluster dependency paths for any dependencies that are not yet connected. Since the multiple cluster dependency paths have already made a number of connections within each cluster, the number of incomplete edges that need to be examined may be drastically reduced, thereby significantly reducing computation time. For example, without partitioning the entire set of projects into clusters, a processor may be forced to consider all projects at once to determine the connected dependencies. In contrast, merging the cluster dependency paths together then allows the system to need to consider only the incomplete edges of the cluster dependency paths, thereby eliminating from consideration many irrelevant projects that either are already connected or don't have any dependencies. This concept of naturally eliminating projects from needing to examine their dependencies may be referred to herein as “pruning.”

At block 1210, now having the complete dependency paths generated, in some embodiments, the dependency paths may be ranked or sorted based on a predetermined value criterion. For example, the value criterion may include how much value each dependency path contributes towards the specified optimization goal. For example, if the optimization goal is to maximize profit, then the complete dependency paths may be ranked by how much estimated profit the completion of each dependency path may bring. In general, dependency paths that better satisfy the value criterion may be said to have a higher “density” than dependency paths that don't. That is, the “density” of dependency path can be a quantitative expression of an amount of overall return of the dependency path. In some embodiments, the “density” of a dependency path includes a ratio of some benefit gained by the projects in the dependency path to a cost associated with completing the projects, while in other cases the “density” of a dependency path includes a difference between the benefit and the costs.

At block 1212, in some embodiments, the system may resolve any remaining unresolved dependencies. For example, projects without any dependencies and other floater projects may also still need to be ranked. In some embodiments, the projects without any dependencies and other floater projects may be ranked in a separate ranking. In some embodiments, a master list of the rankings of the dependency paths and any projects without dependencies or other floaters may be stored for use in later stages of the optimization algorithm according to aspects of the present disclosure.

Referring to FIG. 12B, illustration 1250 provides a graphical depiction of some examples of the directed acyclic graphs. Here, each vertex represents a project in an overall set of projects. The directed edges are represented by arrows pointing to other vertices. Thus, different paths are illustrated in these two example DAG's consistent with the description of the paths shown in illustration 1250, separated by semicolons.

Referring to FIG. 12C, flowchart 1270 provides an example for generating the complete dependency paths, consistent with the descriptions in flowchart 1200. As shown, a set of projects may be randomly partitioned into multiple partitions, where a depth first search to connect the projects in each partition, based on their dependency values, is performed. Then, each of these partial connections may be merged together with the other partial connections from the other random partitions, thereby generating one or more complete dependency paths. Unresolved dependencies may be tied up, such as analyzing and handling projects with no dependencies and other floaters.

Referring to FIG. 13, flowchart 1300 provides an example methodology for determining allocating the projects in block 1118 of FIG. 11, according to some embodiments. Recall that the process for allocating the projects to fit into the specified time horizon includes as an input the generated dependency paths. In some cases, this process includes as an input the dependency paths and floaters in the ranked order. In some embodiments, at block 1302, the system may categorize the dependency paths and the floaters into distinct designations, each designation specifying a degree of importance of the projects in the dependency paths (or standing alone as floaters) to be included into the generated schedule. For example, in some embodiments, the dependency paths and floaters may be categorized into one of three distinct sets: required, preferred, and elective. These designations may be based on predefined attributes about the projects, such as if any of the projects were given any special designations in the project listing 305 in FIG. 3. In some embodiments, for a dependency path with multiple projects having different designations, the system may be configured to designate the overall dependency path based on the highest or most important designation bestowed on any project with in its dependency path. For example, in a dependency path of 10 projects, if even one project was designated as “required,” then the entire dependency path may be designated as required. Projects categorized into a designation with highest importance will be allocated into the schedule first over other projects that have been designated with a lower importance. For example, the projects in the dependency paths and floaters that have been designated as “required,” will be allocated into the schedule before any projects that are designated in the “preferred” category.

At block 1304, in some embodiments, the system may iterate through the dependency paths and floaters to allocate resources. In some embodiments, the system may allocate the resources to the most important and highest value dependency paths and floaters first, continuing on down the line to progressively less important and less valuable dependency paths and floaters. This process may continue until all available resources have been assigned, based on the prescribed roles required of the projects, which in some cases may cause the lowest priority and lowest value dependency paths and floaters to not be allocated any resources. In some embodiments, floater projects may be given resources over multiple projects in a dependency path if the floater has a density greater than the sum of the cumulative density of the projects in the dependency path. In some embodiments, the allocation of resources to the various dependency paths and floaters may also take into consideration other various constraints, such as any budget expenditures associated with the resources, and any budgets associated with a project. For example, a project may have an associated budget, such that it may be determined that certain high-value or expensive resources cannot be devoted to that project. Instead, cheaper resources that can perform the same function may be devoted to the project.

At block 1306, in some embodiments, the system may then fit into the schedule the dependency paths that have all of their resource needs met. Any floaters with a high density value, e.g., greater than the sum of the cumulative density of projects in a dependency path, may also be placed into the schedule before dependency paths with a lower cumulative density. In some embodiments, the system may also contemplate truncating dependency paths of the latest projects in the chain of dependent projects if the time horizon is shorter than the overall estimated time to complete the entire dependency path. Thus, the truncated version of the dependency path may be fit into the schedule. In some embodiments, any remaining floaters that have not yet been allocated may be fit into the schedule, time and resource permitting.

In some embodiments, the system may also allocate resources to roles in projects based on a set of prioritizations. This set of prioritizations may allow the system to more efficiently assign resources, with the reasoning that some resources may be more scarce than others, and that some roles in certain projects may be more valuable than others. The following are some examples of prioritizations that the system may incorporate to guide the allocating of resources to roles, according to some embodiments:

Prioritization of Roles

1. Scarce roles are matched earlier than less scarce ones.
2. Roles whose “contours” have longest non-zero sequence of demands are matched earlier than ones with shorter such contours. In some embodiments, after dependency paths have been generated, a role in a project may be allowed to have more resources devoted to it, say for example due to the project being a high priority, high risk, or having high value. The system may allow for that project to draw additional resources from nearby projects in the dependency path, thereby reducing resource allowances for the other projects but helping to ensure the more devoted project is completed in time. This process of overcompensating on certain roles in a chain of projects creates “contours,” that is, a chain of projects that have one or more roles overcompensated for.
3. Roles with larger commitment, in hours, for the current time-interval in the project are matched earlier than ones with smaller commitments.

Prioritization of Resources

1. Preferred resources are selected earlier than non-preferred resources. In some embodiments, a resource may be preferred if the resource is designated as such. In other cases, the resources that are fewer in number, time, or budget, may be considered as preferred over resources with larger amounts of those metrics.
2. “Sticky” resources are assigned earlier than others, where “sticky” means a resource that was assigned to a time-interval prior to the one under consideration.
3. Inflexible resources are assigned earlier than flexible ones. The inflexibility may be based on predesignated time or location constraints.
4. Resources that have smallest relative error vis a vis role-demand in question. (“Best-match” criteria.)
5. All other things being equal, choose resource with longest availability horizon for role-demand in question.

In some embodiments, the system may also be able to allocate projects according to one or more of the following guidelines:

1. Required projects can be “over-allocated” in the sense of being forcibly assigned even when role-demands overreach available resource capacity. In this case, a best-placement policy may be utilized that results in maximal utilization of available resource capacity.
2. Partial allocations may be supported, subject to a threshold. Splittable and non-shiftable projects are never subject to thresholding.
3. Floaters with a duration>1 time unit (e.g., days, hours, etc.) can be optionally split.
4. Floaters are allocated on the basis of an optimizing heuristic that selects that swath of time-intervals for the floater which minimizes residual resource capacity.
5. Non-shiftable projects can be on a dependency path.
6. Budget can be “recontoured” when some time-interval is under-budget. One example is by favoring the earliest eligible time-interval where a recontouring opportunity is viable.

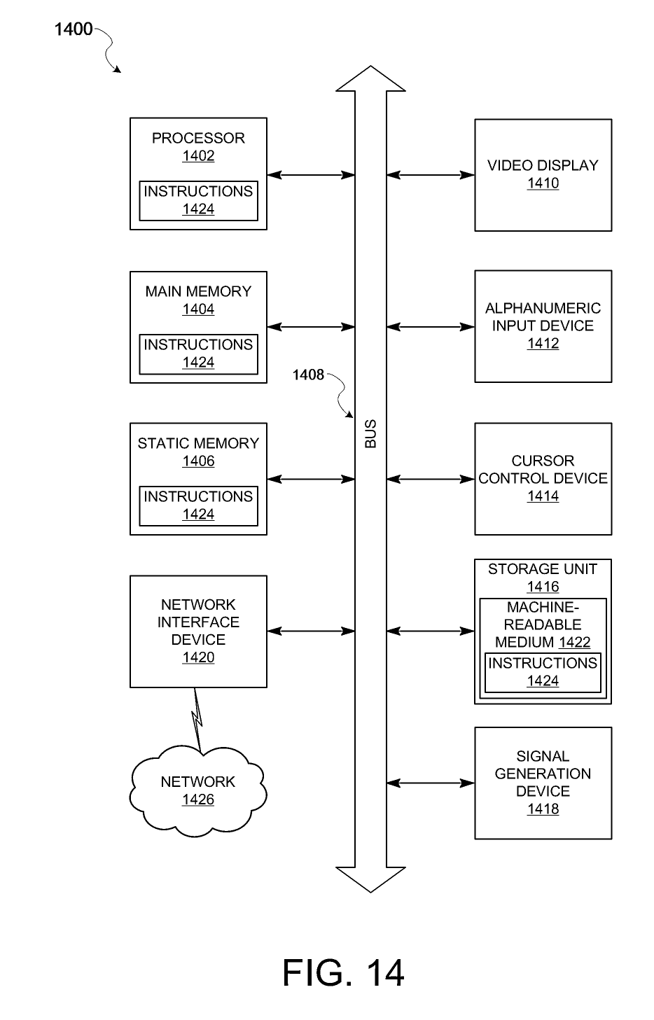

Referring to FIG. 14, the block diagram illustrates components of a machine 1400, according to some example embodiments, able to read instructions 1424 from a machine-readable medium 1422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 14 shows the machine 1400 in the example form of a computer system (e.g., a computer) within which the instructions 1424 (e.g., software, a program, an application, an applet, an app, or other executable code) for causing the machine 1400 to perform any one or more of the methodologies discussed herein may be executed, in whole or in part.

In alternative embodiments, the machine 1400 operates as a standalone device or may be connected (e.g., networked) to other machines. In a networked deployment, the machine 1400 may operate in the capacity of a server machine 110 or a client machine in a server-client network environment, or as a peer machine in a distributed (e.g., peer-to-peer) network environment. The machine 1400 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1424, sequentially or otherwise, that specify actions to be taken by that machine. Further, while only a single machine 1400 is illustrated, the term “machine” shall also be taken to include any collection of machines that individually or jointly execute the instructions 1424 to perform all or part of any one or more of the methodologies discussed herein.

The machine 1400 includes a processor 1402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1404, and a static memory 1406, which are configured to communicate with each other via a bus 1408. The processor 1402 may contain microcircuits that are configurable, temporarily or permanently, by some or all of the instructions 1424 such that the processor 1402 is configurable to perform any one or more of the methodologies described herein, in whole or in part. For example, a set of one or more microcircuits of the processor 1402 may be configurable to execute one or more modules (e.g., software modules) described herein.

The machine 1400 may further include a video display 1410 (e.g., a plasma display panel (PDP), a light emitting diode (LED) display, a liquid crystal display (LCD), a projector, a cathode ray tube (CRT), or any other display capable of displaying graphics or video). The machine 1400 may also include an alphanumeric input device 1412 (e.g., a keyboard or keypad), a cursor control device 1414 (e.g., a mouse, a touchpad, a trackball, a joystick, a motion sensor, an eye tracking device, or other pointing instrument), a storage unit 1416, a signal generation device 1418 (e.g., a sound card, an amplifier, a speaker, a headphone jack, or any suitable combination thereof), and a network interface device 1420.

The storage unit 1416 includes the machine-readable medium 1422 (e.g., a tangible and non-transitory machine-readable storage medium) on which are stored the instructions 1424 embodying any one or more of the methodologies or functions described herein, including, for example, any of the descriptions of FIGS. 1-13. The instructions 1424 may also reside, completely or at least partially, within the main memory 1404, within the processor 1402 (e.g., within the processor's cache memory), or both, before or during execution thereof by the machine 1400. The instructions 1424 may also reside in the static memory 1406.

Accordingly, the main memory 1404 and the processor 1402 may be considered machine-readable media 1422 (e.g., tangible and non-transitory machine-readable media). The instructions 1424 may be transmitted or received over a network 1426 via the network interface device 1420. For example, the network interface device 1420 may communicate the instructions 1424 using any one or more transfer protocols (e.g., HTTP). The machine 1400 may also represent example means for performing any of the functions described herein, including the processes described in FIGS. 1-13.

In some example embodiments, the machine 1400 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1422 able to store data temporarily or permanently and may be taken to include, but not be limited to, random-access memory (RAM), read-only memory (ROM), buffer memory, flash memory, and cache memory. While the machine-readable medium 1422 is shown in an example embodiment to be a single medium, the term “machine-readable medium” should be taken to include a single medium or multiple media (e.g., a centralized or distributed database 115, or associated caches and servers) able to store instructions 1424. The term “machine-readable medium” shall also be taken to include any medium, or combination of multiple media, that is capable of storing the instructions 1424 for execution by the machine 1400, such that the instructions 1424, when executed by one or more processors of the machine 1400 (e.g., processor 1402), cause the machine 1400 to perform any one or more of the methodologies described herein, in whole or in part. Accordingly, a “machine-readable medium” refers to a single storage apparatus or device 130m 140, or 150, as well as cloud-based storage systems or storage networks that include multiple storage apparatus or devices 130, 140 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1422 is non-transitory in that it does not embody a propagating signal. However, labeling the tangible machine-readable medium 1422 as “non-transitory” should not be construed to mean that the medium is incapable of movement; the medium should be considered as being transportable from one physical location to another. Additionally, since the machine-readable medium 1422 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1422 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1402 or a group of processors 1402) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1402 or other programmable processor 1402. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1408) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1402 that are temporarily configured (e.g., by software) or permanently configured to perform the relevant operations. Whether temporarily or permanently configured, such processors 1402 may constitute processor-implemented modules that operate to perform one or more operations or functions described herein. As used herein, “processor-implemented module” refers to a hardware module implemented using one or more processors 1402.

Similarly, the methods described herein may be at least partially processor-implemented, a processor 1402 being an example of hardware. For example, at least some of the operations of a method may be performed by one or more processors 1402 or processor-implemented modules. As used herein, “processor-implemented module” refers to a hardware module in which the hardware includes one or more processors 1402. Moreover, the one or more processors 1402 may also operate to support performance of the relevant operations in a “cloud computing” environment or as a “software as a service” (SaaS). For example, at least some of the operations may be performed by a group of computers (as examples of machines 1400 including processors 1402), with these operations being accessible via a network 1426 (e.g., the Internet) and via one or more appropriate interfaces (e.g., an API).

The performance of certain operations may be distributed among the one or more processors 1402, not only residing within a single machine 1400, but deployed across a number of machines 1400. In some example embodiments, the one or more processors 1402 or processor-implemented modules may be located in a single geographic location (e.g., within a home environment, an office environment, or a server farm). In other example embodiments, the one or more processors 1402 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 1400 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method comprising:
accessing, by a processor, a plurality of projects;
accessing, by the processor, a time horizon indicating a length of time to complete at least a subset of projects in the plurality of projects;
accessing, by the processor, a plurality of resources, wherein each resource in the plurality of resources specifies one or more functions that can be performed by the resource toward completing at least one project in the plurality of projects;
accessing, by the processor, for each resource in the plurality of resources, a budget expenditure indicating a maximum available capacity that each resource can be used across the plurality of projects;
accessing, by the processor, for each project in the plurality of projects, a cost constraint associated with completing said project;
accessing, by the processor, for each project in the plurality of projects, a benefit value indicating an amount of benefit gained with completing said project;
accessing, by the processor, a set of project dependency values indicating which projects in the plurality of projects must be completed as requisite for completing other projects in the plurality of projects;
determining, by the processor, at least one dependency path indicating an ordering of projects among the plurality of projects to be completed, based on the set of project dependency values, wherein a project in the at least one dependency path cannot be started until all preceding projects in the at least one dependency path are completed; and
determining, by the processor, an efficient selection of projects among the plurality of projects to be completed within the time horizon based on a comparison between the benefit values of each project in the efficient selection of projects and the cost constraints of each project in the efficient selection of projects, the efficient selection based on the at least one dependency path and determining an efficient utilization of the plurality of resources to complete the efficient selection of projects, constrained by the budget expenditures for each resource.

2. The method of claim 1, wherein determining the at least one dependency path comprises:
partitioning the plurality of projects into a plurality of clusters;
computing a cluster dependency path for each cluster indicating, for each project in the cluster, a sequence of projects among the plurality of projects linked by the project dependency values associated with said project in the cluster;
performing a merging operation of the cluster dependency paths to generate the at least one dependency path; and
pruning at least a subset of at least one of the cluster dependency paths that is not relevant to the at least one dependency path during the merging operation.

3. The method of claim 2, wherein the merging operation comprises splicing at least two cluster dependency paths together, a selection of the at least two cluster dependency paths to be spliced based on at least one project being in common among the at least two cluster dependency paths.

4. The method of claim 1, wherein determining the at least one dependency path comprises:
determining a first dependency path based on the set of project dependency values;
determining a second dependency path based on the set of project dependency values;
ranking the first dependency path over the second dependency path based on a comparison between estimated returns of the first and second path dependencies; and
allocating along a timeline constrained by the time horizon the projects in the first dependency path before allocating along the timeline the projects in the second dependency path.

5. The method of claim 1, wherein determining the efficient selection of projects among the plurality of projects to be completed comprises determining an efficient placement for a project on a timeline constrained by the time horizon, the efficient placement based on a time-length for completing the project, an amount of resources needed to complete the project, and a project budget defining maximum financial costs for the project.

6. The method of claim 5, wherein determining the efficient placement for the project comprises:
matching the resources with roles in the project;
prioritizing a selection of the resources to be matched with the roles; and
prioritizing a selection of the roles to be matched with the resources.

7. The method of claim 6, wherein prioritizing a selection of the resources comprises:
selecting preferred resources earlier than non-preferred resources;
assigning sticky resources earlier than non-sticky resources, the sticky resources indicating a resource that was assigned to a time-interval prior to the role being considered;
assigning inflexible resources earlier than flexible resources;
assigning resources to roles that match a best-fit description of the roles; and
favoring resources with a longer availability horizon over resources with a shorter availability horizon.

8. The method of claim 6, wherein prioritizing a selection of the roles comprises:
matching scarce roles before less scarce roles;
matching roles whose contours have a longer non-zero sequence of demands before roles with shorter contours; and
matching roles with larger time commitments before roles with shorter time commitments.

9. The method of claim 1, wherein determining the efficient selection of projects among the plurality of projects to be completed comprises determining reasons for why a project among the plurality of projects is excluded among the efficient selection of projects.

10. The method of claim 9, wherein determining why the project is excluded comprises:
determining if a budget shortfall caused the project to be excluded;
determining if a resource shortfall caused the project to be excluded;
determining if a timeline shortfall caused the project to be excluded; and
determining if a dependency path shortfall caused the project to be excluded.

11. The method of claim 1, wherein determining the efficient selection of projects among the plurality of projects to be completed comprises revising a set of project constraints to determine if at least one more project among the plurality of projects not currently included among the efficient selection of projects can be included among the efficient selection.

12. The method of claim 11, wherein revising the set of project constraints comprises:
determining if revising a number of roles for completing the efficient selection of projects results in one or more projects being included among the efficient selection of projects;
determining if increasing at least one budget associated with the efficient selection of projects results in one or more projects being included among the efficient selection of projects; or
determining if increasing capacity of a role within a project among the efficient selection of projects results in one or more projects being included among the efficient selection of projects.

13. The method of claim 1, wherein determining the efficient selection of projects among the plurality of projects to be completed within the time horizon is based further on maximizing the comparison between the benefit values of each project in the efficient selection of projects and the cost constraints of each project in the efficient selection of projects.

14. A system comprising:
a memory configured to store data comprising:
a plurality of projects;
a time horizon indicating a length of time to complete at least a subset of projects in the plurality of projects;
a plurality of resources, wherein each resource in the plurality of resources specifies one or more functions that can be performed by the resource toward completing at least one project in the plurality of projects;
for each resource in the plurality of resources, a budget expenditure indicating a maximum available capacity that each resource can be used across the plurality of projects;
for each project in the plurality of projects, a cost constraint indicating financial costs associated with completing said project;
for each project in the plurality of projects, a benefit value indicating an amount of benefit gained with completing said project; and
a set of project dependency values indicating which projects in the plurality of projects must be completed as requisite for completing other projects in the plurality of projects; and
a processor coupled to the memory and configured to:
access the plurality of projects, the time horizon, the plurality of resources, the budget expenditure for each resource in the plurality of resources, the cost constraint for each project in the plurality of projects, the benefit value for each project in the plurality of projects, and the set of project dependency values;
determine at least one dependency path indicating an ordering of projects among the plurality of projects to be completed, based on the set of project dependency values, wherein a project in the at least one dependency path cannot be started until all preceding projects in the at least one dependency path are completed; and
determine an efficient selection of projects among the plurality of projects to be completed within the time horizon based on a comparison between the benefit values of each project in the efficient selection of projects and the cost constraints of each project in the efficient selection of projects, the efficient selection based on the at least one dependency path and determining an efficient utilization of the plurality of resources to complete the efficient selection of projects, constrained by the budget expenditures for each resource.

15. The system of claim 14, wherein determining the at least one dependency path comprises:
partitioning the plurality of projects into a plurality of clusters;
computing a cluster dependency path for each cluster indicating, for each project in the cluster, a sequence of projects among the plurality of projects linked by the project dependency values associated with said project in the cluster;
performing a merging operation of the cluster dependency paths to generate the at least one dependency path; and
pruning at least a subset of at least one of the cluster dependency paths that is not relevant to the at least one dependency path during the merging operation.

16. The system of claim 15, wherein the merging operation comprises splicing at least two cluster dependency paths together, a selection of the at least two cluster dependency paths to be spliced based on at least one project being in common among the at least two cluster dependency paths.

17. The system of claim 14, wherein determining the at least one dependency path comprises:
determining a first dependency path based on the set of project dependency values;
determining a second dependency path based on the set of project dependency values;
ranking the first dependency path over the second dependency path based on a comparison between estimated returns of the first and second path dependencies; and
allocating along a timeline constrained by the time horizon the projects in the first dependency path before allocating along the timeline the projects in the second dependency path.

18. The system of claim 14, wherein determining the efficient selection of projects among the plurality of projects to be completed comprises determining an efficient placement for a project on a timeline constrained by the time horizon, the efficient placement based on a time-length for completing the project, an amount of resources needed to complete the project, and a project budget defining maximum financial costs for the project.

19. The system of claim 18, wherein determining the efficient placement for the project comprises:
matching the resources with roles in the project;
prioritizing a selection of the resources to be matched with the roles based on:
selecting preferred resources earlier than non-preferred resources;
assigning sticky resources earlier than non-sticky resources, the sticky resources indicating a resource that was assigned to a time-interval prior to the role being considered;
assigning inflexible resources earlier than flexible resources;
assigning resources to roles that match a best-fit description of the roles; and
favoring resources with a longer availability horizon over resources with a shorter availability horizon; and
prioritizing a selection of the roles to be matched with the resources based on:
matching scarce roles before less scarce roles;
matching roles whose contours have a longer non-zero sequence of demands before roles with shorter contours; and
matching roles with larger time commitments before roles with shorter time commitments.

20. A non transitory computer readable medium comprising instructions that, when interpreted by a processor, cause a machine to perform operations comprising:
accessing a plurality of projects;
accessing a time horizon indicating a length of time to complete at least a subset of projects in the plurality of projects;
accessing a plurality of resources, wherein each resource in the plurality of resources specifies one or more functions that can be performed by the resource toward completing at least one project in the plurality of projects;
accessing for each resource in the plurality of resources, a budget expenditure indicating a maximum available capacity that each resource can be used across the plurality of projects;
accessing for each project in the plurality of projects, a cost constraint indicating financial costs associated with completing said project;
accessing for each project in the plurality of projects, a benefit value indicating an amount of benefit gained with completing said project;
accessing a set of project dependency values indicating which projects in the plurality of projects must be completed as requisite for completing other projects in the plurality of projects;
determining at least one dependency path indicating an ordering of projects among the plurality of projects to be completed, based on the set of project dependency values, wherein a project in the at least one dependency path cannot be started until all preceding projects in the at least one dependency path are completed; and
determining an efficient selection of projects among the plurality of projects to be completed within the time horizon based on a comparison between the benefit values of each project in the efficient selection of projects and the cost constraints of each project in the efficient selection of projects, the efficient selection based on the at least one dependency path and determining an efficient utilization of the plurality of resources to complete the efficient selection of projects, constrained by the budget expenditures for each resource.
